(19) United States
(12) Patent Application Publication
(10) Pub. No.: US 2023/0014636 A1
(43) Pub. Date: Jan. 19, 2023

(54) Movable Barrier Operator System

(71) Applicant: The Chamberlain Group LLC, Oak Brook, IL (US)

(72) Inventors: Luis Giron, Darien, IL (US); Oddy Khamharn, Lombard, IL (US); Edward James Lukas, Batavia, IL (US); Michael Rankin, Chicago, IL (US); Adelaide Zhang, Northbrook, IL (US)

(21) Appl. No.: 17/860,536

(22) Filed: Jul. 8, 2022

Related U.S. Application Data
(60) Provisional application No. 63/222,909, filed on Jul. 16, 2021.

(51) Int. Cl. E05F 15/77; E05F 15/668

(52) U.S. Cl. CPC E05F 15/77; E05F 15/668; E05Y 2400/66; E05Y 2900/106

(57) ABSTRACT

A movable barrier operator system is provided. The system includes a control circuit, an electric motor; and communication circuitry. The control circuit is configured to control operation of the electric motor based on a control signal received by the communication circuitry.

### CROSS-REFERENCE TO RELATED APPLICATION(S)

This application claims the benefit of U.S. Provisional Patent Application No. 63/222,909, filed Jul. 16, 2021, which is incorporated by reference in its entirety herein.

### TECHNICAL FIELD

This disclosure relates to movable barrier operators and, more specifically, to controlling a movable barrier operator.

### BACKGROUND

Movable barrier operators are known, such as garage door operators and gate operators, which move movable barriers such as garage doors, gates, and rolling shutters. Many residences have at least one garage door. The garage door is generally coupled to a garage door operator that enables a user to remotely open and close the garage door using a transmitter. The transmitter transmits a control signal to the garage door operator including a code. The garage door operator authenticates the code and effects a state change of the garage door.

### BRIEF DESCRIPTION OF THE DRAWINGS

FIG. 1 is a view of an example garage door operator system for operating a garage door;

FIG. 2 is a block diagram of an example garage door operator;

FIG. 3 is an example communication diagram utilized with a garage door operator system;

FIG. 4 is an example communication network diagram utilized with a garage door operator system;

FIG. 5 is an example communication flow diagram utilized with a garage door operator system;

FIG. 6 illustrates example operation of a garage door operator system;

FIG. 7 further illustrates example operation of a garage door operator system; and

FIG. 8 is yet another illustration of an example operation of a garage door operator system.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

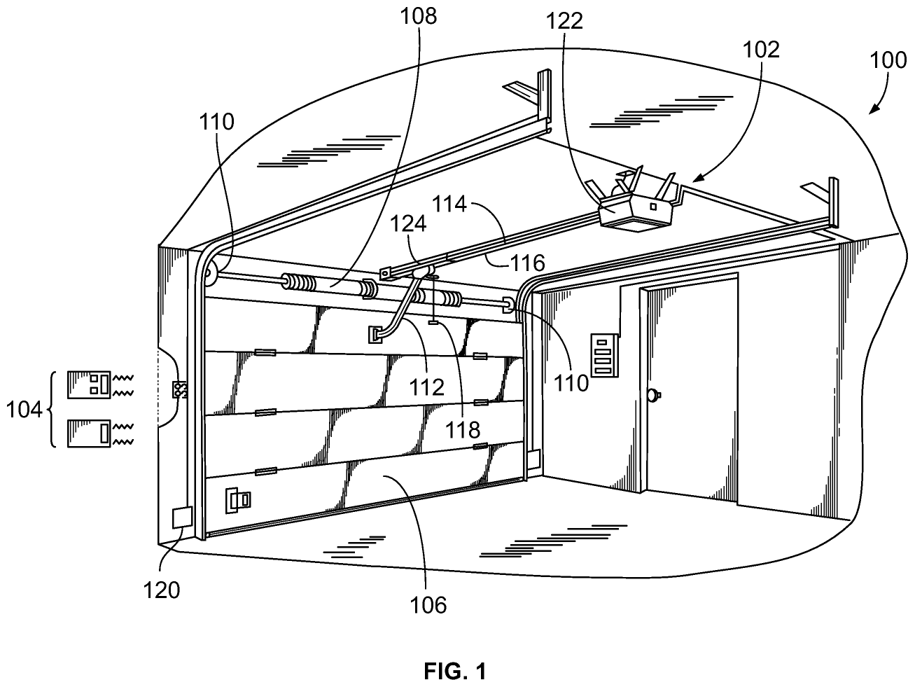

With reference to FIG. 1, a movable barrier operator system such as garage door operator system 100 is provided for operating a movable barrier such as a garage door 106 in accordance with some embodiments. The garage door operator system 100 includes a garage door operator 102 and one or more remote controls such as a transmitter 104. The one or more remote controls may include, for example, a user device such as a smartphone, an in-vehicle device such as a head unit or infotainment system coupled to an in-vehicle transmitter, a keypad, a wall control, a visor-mounted remote control, and/or a handheld transmitter such as a key fob. The garage door operator 102 includes an electric motor 122, communication circuitry, and a control circuit. In some embodiments, the garage door operator includes a rail 116 and an elongate member 114 such as a chain, belt or screw driven by the motor relative to the rail 116. The electric motor 122 lifts (or opens) and lowers (or closes) the garage door 106. For example, a trolley 124 is coupled to the belt/chain/screw as well as an arm 112 that is attached to the garage door 106. The motor 122 shifts the trolley 124 back and forth on the rail 116 to lift and lower the garage door 106. A release mechanism 118 is coupled to the trolley 124 to allow the garage door 106 to be disconnected from the garage door operator 102 for manual operation e.g. during a power failure.

The garage door operator system 100 includes a pulley and cable mechanism 110 that is attached to the garage door 106. The pulley and cable mechanism 110 includes a pulley and a corresponding cable on each side of the garage door 106. The pulley and cable mechanism 110 couples to a counterbalance such as a torsion spring 108 that lifts the weight of the garage door 106 and enables the garage door operator 102 to open or close the garage door 106 via movement of the trolley 124. In some embodiments, a photo eye system 120 senses an object and/or a human who may be in the way of the garage door 106 as the garage door 106 closes.

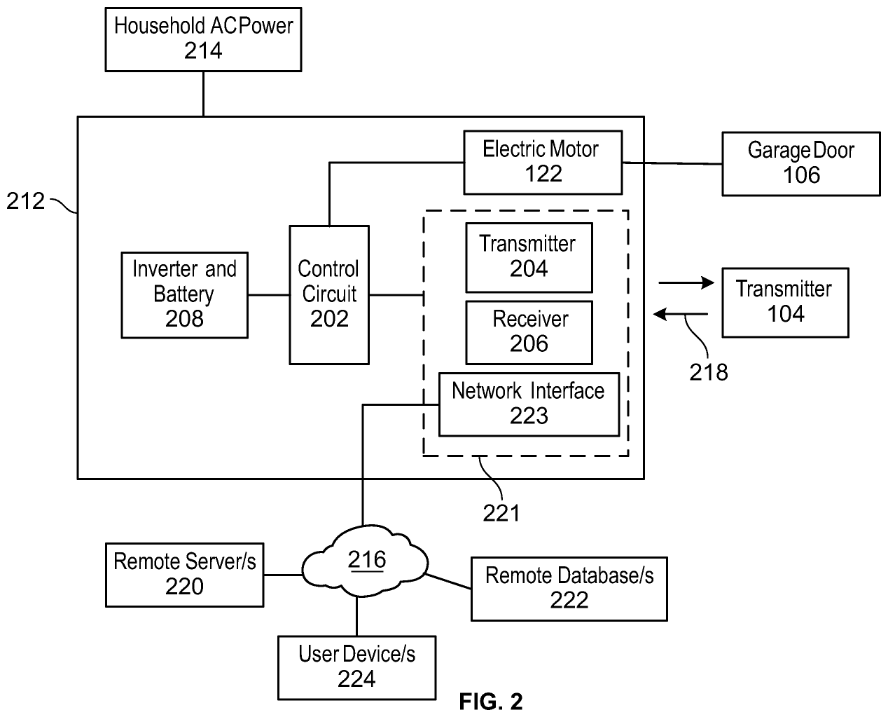

FIG. 2 illustrates a simplified block diagram of an exemplary garage door operator 212 for operating a garage door 106 in accordance with some embodiments. In some embodiments, the garage door operator 212 may correspond to the garage door operator 102 of FIG. 1. The garage door operator 212 may include a control circuit 202 having a processor and a memory, an electric motor 122, and communication circuitry 221 including a transmitter 204, a receiver 206, and a network interface 223. The garage door operator 212 further includes an inverter and battery 208. The inverter and battery 208 may switch household AC power 214 to DC power that may be used to energize the garage door operator 212. In some embodiment, the control circuit 202 controls operations of the electric motor 122 based on a control signal received from the transmitter 104 via the receiver 206. The communications of rolling/changing codes between the garage door operator 212 and the transmitter 104 may be unidirectional or bidirectional as discussed in U.S. Pat. No. 10,652,743, titled Security System for a Movable Barrier Operator, which issued on May 12, 2020, and is hereby incorporated by reference herein. In some configurations, the communication circuitry 221 may include a transceiver to perform the functions of a transmitter 204 and the receiver 206. In some embodiment, the communication circuitry 221 may communicatively couple to a communication network 216 (e.g., wired and/or wireless such as a local Wi-Fi network and the Internet). The garage door operator 212 may be remotely operated, programmed, and/or controlled by a user via the communication network 216 using a remote device such as remote server 220, user device 224, and/or an in-vehicle device (e.g., a vehicle telematics or infotainment system).

Back Channel Communication

Once a secure connection is established (e.g., via a protocol disclosed in the '743 patent) between the transmitter 104 (e.g., a trainable transceiver such as a HomeLink® universal garage opener remote control) and the garage door operator 102, the established communication path is available for a few seconds to perform the opening and closing of the garage door 106, then the secure connection may be closed. However, in some situations, the communication protocol between the two endpoints (the transmitter 104 and the garage door operator 102) is augmented by maintaining the communication path for a predetermined or variable period of time after authentication while a back-channel communication path 218 is established that can be used for large data exchanges. In one embodiment, the transmitter 104 is an in-vehicle transmitter having a transceiver to communicate with the garage door operator 212. The transmitter 104 is operably coupled to a network interface of the vehicle (e.g., cellular such as 3G, 4G, 4G LTE, 5G, etc. and/or Wi-Fi). The garage door operator 212 operates as an intermediary between the transmitter 104 and a remote device such as the remote server 220. This back-channel communication 218 can support new use cases such as: diagnostics, status/control of an endpoint, firmware/software updates, photo and video transfers, and/or communication with other endpoint devices (e.g., a door lock, a security system, a light, etc.) in the vicinity. Thus, the present disclosure leverages the secure communication channel that has been established between the garage door operator 212 and the transmitter 104 for use cases other than the typical opening and closing of the garage door 106.

For example, the back channel communication 218 may support one or more of the following use cases: (1) diagnostics, e.g. to help troubleshoot the transmitter 104 or a system/subsystem of a vehicle to which the transmitter is coupled; (2) status and control of an endpoint; (3) firmware/software update, to provide over-the-air update opportunity for new features, patches or bug fixes for endpoints; (4) transfer large data to endpoints such as images or videos to assist vehicle activities (e.g., self-parking and valet operations) inside of the garage; and (5) communicate/connection with other endpoints in the vicinity to assist vehicle activities while the vehicle is inside of the garage. Those skilled in the art will understand that the back channel communication 218 may also be used for purposes other than and/or in addition to the aforementioned use cases since the path of the back channel communication 218 is configured with a bandwidth and/or connection uptime to handle large data exchanges between two or more endpoints. For example, an endpoint may include the garage door operator 102, an in-vehicle trainable transmitter, a hand-held transmitter, and/or any portable electronic devices capable of functioning as a transmitter 104 and/or providing functionality as a user interface to the garage door operator 102. In some embodiments, the control circuit 202 may communicate via the network interface 223 and the communication network 216 with one or more remote servers 220, databases 222, and/or user devices 224 to perform, at least in part, one or more of aforementioned use cases.

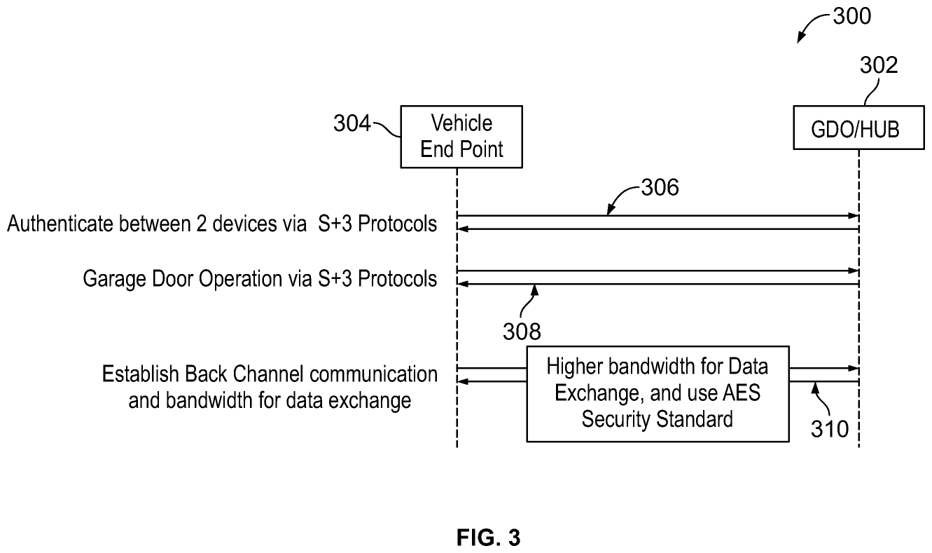

FIG. 3 is an illustration of an example communication diagram 300 used in a garage door operation in accordance with some embodiments. In some embodiments, the communication diagram 300 is used in garage door operations illustrated and described in FIGS. 1 and 2. In some embodiments, a vehicle endpoint 304 may correspond to the vehicle transmitter 104 described above. In some embodiments, a garage door operator endpoint 302 may correspond to the garage door operator 212 and/or the garage door operator 102 described above. The garage door operator endpoint 302 may include a garage door operator (e.g. garage door operator 102 or 212 discussed above) and/or a hub that augments functionality of a legacy/pre-installed operator, such as a movable barrier operator enhancement device as disclosed in U.S. Pat. No. 10,801,247, titled Barrier Operator Feature Enhancement, which issued on Oct. 13, 2020, which is hereby incorporated by reference herein. In an illustrative non-limiting example at step 306, the vehicle endpoint 304 may transmit an authentication signal to the garage door operator endpoint 302 via S+3 (i.e. the previously-mentioned bidirectional rolling code communication method) protocols and/or the like to establish a bi-directional authenticated communication channel between the vehicle endpoint 304 and the garage door operator endpoint 302. After authentication, at step 308, a garage door operation via one or more protocols disclosed in the '743 patent is performed. At step 310, while maintaining the authenticated communication channel, a control circuit of the garage door operator endpoint 302 establishes a back channel communication (e.g., the back channel communication 218 of FIG. 2) that is configured to have bandwidth and/or an uptime that provides for large data exchanges relative to the communication channel for authentication and for opening and/or closing of the garage door as shown in steps 306 and 308. In some embodiments, the back channel communication may additionally provide for advanced encryption standard (AES) to secure the data transmissions over the back channel communication between the vehicle endpoint 304 and the garage door operator endpoint 302.

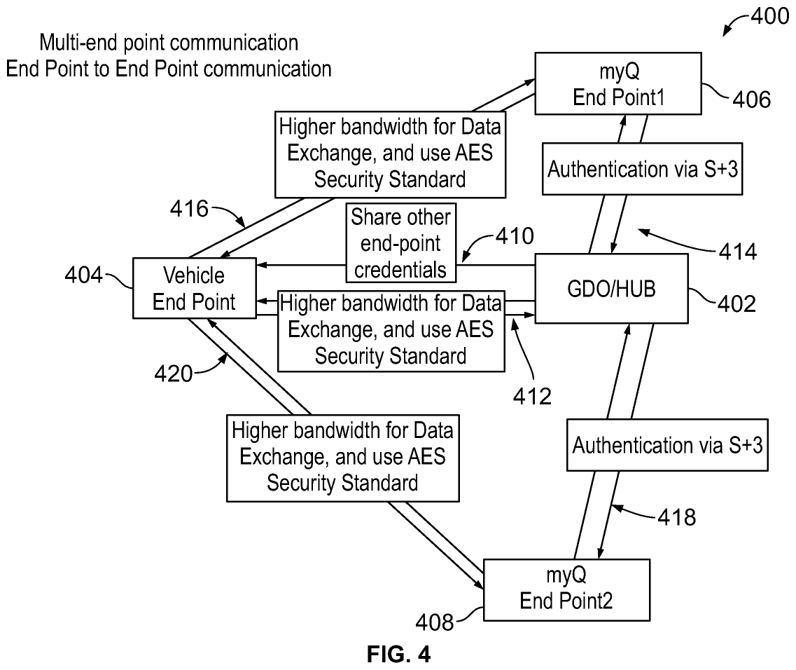

FIG. 4 is an illustration of an example communication network diagram 400 used with one or more garage door operators disclosed herein. In some embodiments, a vehicle endpoint 404 may correspond to the transmitter 104 and/or the vehicle endpoint 304 discussed above. In some embodiments, a garage door operator (GDO/HUB) endpoint 402 may correspond to the garage door operator 212, the garage door operator 102, and/or the garage door operator endpoint 302 described above. In some embodiments, one or more steps shown in the communication network diagram 300 of FIG. 3 is implemented in the vehicle endpoint 404 and the garage door operator endpoint 402.

In an illustrative non-limiting example, multi-endpoint and endpoint to endpoint communications are shown in FIG. 4. At step 410, after authentication has occurred between the vehicle endpoint 404 and the garage door operator endpoint 402 (for example, as described in FIG. 3), the garage door operator endpoint 402 may transmit credentials of one or more other endpoints to the vehicle endpoint 404 in order for the vehicle endpoint 404 to establish an endpoint to endpoint (e.g. direct ad-hoc peer to peer connection or session) communication with other endpoints, such as user device first endpoint 406 and user device second endpoint 408. In some embodiments, the user device endpoints 406, 408 may facilitate operation and/or monitoring of the garage door operator such as via communicating with a remote server associated with a user account. For example, the endpoints 406, 408 may communicate with a myQ® server. myQ® is a smart home service offered by The Chamberlain Group, Inc. of Oak Brook, Illinois. In some configurations, the user device first endpoint 406 and/or the user device second endpoint 408 may each include a user device having an application installed and configured to remotely transmit control signals, status requests and/or user-defined settings to the garage door operator endpoint 402 and/or establish direct or indirect communication with the vehicle endpoint 404. For example, the user device may include a smartphone, a laptop computer, a tablet computer, and/or any user electronic devices capable of installing and/or executing the application that is configured to communicatively couple to the garage door operator endpoint 402 and/or the vehicle endpoint 404.

In some embodiments, the garage door operator endpoint 402 stores endpoints' credentials in a remote and/or local database and/or memory (e.g., a random access memory, a read only memory, a solid state drive, a hard drive, and/or any non-transitory computer readable medium capable of storing electronic data for later retrieval and/or access). For example, the user device first endpoint 406 and the user device second endpoint 408 may each initially and separately setup authentication credential s/details/information (e.g., login/password information and/or electronic device-to-electronic device code synchronization) with the door operator endpoint 402. Once the initial authentication setup is completed, a control circuit of the garage door operator endpoint 402 may cause the resulting authentication credentials to be stored. For example, at step 414 and at step 418, the user device first endpoint 406 and the user device second endpoint 408 may each authenticate with the door operator endpoint 402 via one or more protocols as disclosed in the '743 patent. In some embodiments, at step 416 and at step 420, the user device first endpoint 406 and the user device second endpoint 408 may each establish a back channel communication with the vehicle endpoint 404 wherein the back channel communication is configured to have bandwidth and/or uptime that provides for large data exchanges relative to the data transmitted for authentication and for opening and/or closing of the garage door. In some embodiments, the back channel communication may be encrypted e.g. via AES or the like to secure the data transmissions over the back channel communication between the vehicle endpoint 404 and the user device first endpoint 406 and/or the user device second endpoint 408. In some embodiments, at step 412, the vehicle endpoint 404 may establish a back channel communication using AES security standard with the door operator endpoint 402 in order to transmit and receive large data exchanges between these two endpoints. In another illustrative non-limiting example, a user device such as the user device second endpoint 408 may initiate a firmware update of the firmware of the vehicle endpoint 404 at step 420. In some embodiments, the user device second endpoint 408 may authenticate with the door operator endpoint 402 at step 418. In response, the door operator endpoint 402 may provide credentials associated with the user device second endpoint 408 to the vehicle endpoint 404 in order for the user device second endpoint 408 to provide the firmware update to the vehicle endpoint 404.

Avoiding Accidental Learn

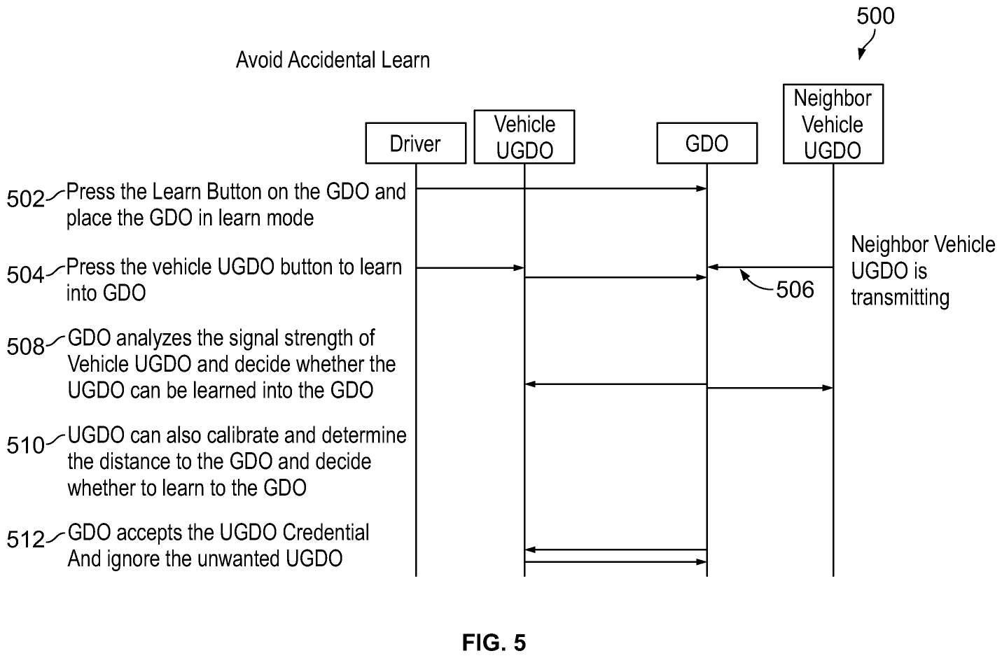

FIG. 5 is an illustration of an example communication flow diagram 500 utilized with a garage door operator system in accordance with some embodiments. In particular, the communication network diagram 500 illustrates the steps that a garage door operator system (e.g., the garage door operator system 100 of FIG. 1) and/or a garage door operator (e.g., the garage door operator 102 or the garage door operator 212) executes to avoid accidental learning by the garage door operator of a nearby/proximate (e.g., neighbor's) transmitter (e.g., a hand-held transmitter or an in-vehicle transmitter).

In one embodiment, based on the establishment of the S+3 bi-directional communication for example, the garage door operator may identify the “desired” transmitter to be learned by monitoring the signal strength of the “desired” transmitter. The signal of the transmitter may be communicated using a radio frequency (RF) signal, such as a signal in the 300-900 MHz range and/or a signal communicated using a Bluetooth® protocol. In an illustrative non-limiting example, the “desired” transmitter corresponds to the vehicle transmitter. It is understood that the process described herein is equally applicable to other transmitters (e.g., hand-held transmitters and exterior keypads). For example, during the learn process, a to-be-learned vehicle transmitter may be parked in front of the garage and/or in proximity to the garage door 106. In some embodiments, at step 502, a user presses the learn button associated with and/or located on the garage door operator (GDO). At step 504, the user presses the vehicle transmitter button to cause the vehicle transmitter to communicate a control signal that is learned by the GDO. In some embodiments, the pressing of the vehicle transmitter button may cause a transmitter of the vehicle transmitter to initiate a periodic and/or a continuous transmission and/or broadcast of a radio frequency (RF) signal. In one example, a receiver (e.g., the receiver 206 of FIG. 2) of the GDO receives and/or otherwise detects the RF signal transmitted by the vehicle transmitter. A control circuit (e.g., the control circuit 202 of FIG. 2) of the GDO may, at step 508, analyze the signal strength of the RF signal and determine whether the signal strength is equal to or greater than a signal strength threshold. By one approach, when the signal strength is equal to or greater than the signal strength threshold, the GDO may process the signal to learn the vehicle transmitter. In another example, during the learn process at step 506, a neighbor's vehicle transmitter may be transmitting a second RF signal and subsequently received by the GDO. The control circuit of the GDO may analyze the received second RF signal and determine that the received second RF signal has a signal strength that is less than the signal strength threshold. In response, the control circuit of the GDO may determine that the source of the second RF signal is not in the proximate vicinity of the GDO. In response, the control circuit of the GDO may prompt the user whether the user wants the GDO to learn the source of the second RF signal (in this example, the neighbor's vehicle transmitter). In some embodiments, in prompting the user, the control circuit of the GDO may cause a user interface, such as an LED associated with and/or located on the GDO, to flash and/or the control circuit sends an alert message to a user device associated with the user (e.g., the user device first endpoint 406 and/or the user device second endpoint 408 of FIG. 4). At step 512, the GDO may accept the transmitter credential (a fixed code and a rolling code of the received RF signal) of the vehicle transmitter and ignore the unchosen and/or unwanted transmitter (e.g., the neighbor's vehicle transmitter).

In some embodiments, at step 510, the vehicle transmitter may alternatively and/or additionally calibrate and determine the distance to the GDO and decide whether to learn to the GDO. For example, in pressing the learn button on the GDO at step 502, the control circuit of the GDO may cause a transmitter (e.g., a transmitter 204 of FIG. 2) to initiate a periodic and/or a continuous transmission and/or broadcast of a radio frequency (RF) signal. In some embodiments, a control circuit associated with the vehicle transmitter may analyze the received RF signal and determine the distance between the vehicle transmitter and the GDO. By one approach, based on the determined distance, the vehicle transmitter may decide whether to initiate a learning process with the GDO.

Detect Whether a Vehicle is Outside or Inside a Garage

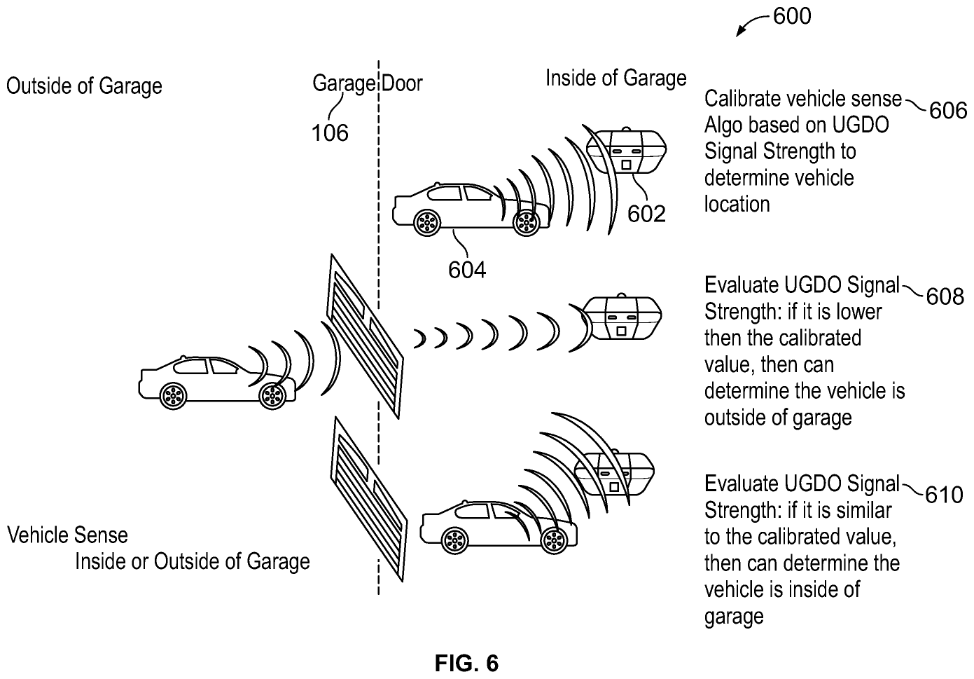

FIG. 6 is an illustration of an example operation of a garage door operator system 600. The system 600 includes a garage door operator 602 and a vehicle transmitter 604. In some embodiments, the garage door operator 602 may correspond to the garage door operator 102, the garage door operator 212 of FIG. 2, the garage door operator endpoint of FIG. 3, the garage door operator endpoint of FIG. 4, and/or the GDO of FIG. 5. In some embodiments, the vehicle transmitter 604 may correspond to the transmitter 104 of FIG. 1 and/or 2, the vehicle endpoint 304 of FIG. 3, the vehicle endpoint 404 of FIG. 4, and/or the vehicle transmitter described with respect to FIG. 5.

In some embodiments, a bi-directional communication link (for example using the Bluetooth® wireless technology and a security protocol of the '743 patent) is established between the garage door operator 602 and the vehicle transmitter 604. The garage door operator (GDO) 602 (or the corresponding control circuit of the garage door operator 602) may determine whether a vehicle associated with the vehicle transmitter 604 is inside or outside a garage. In some embodiments, the resulting determination may be based upon, effected by or otherwise initiated relative to an input to determine whether a user may safely remote-start the vehicle, prompt the user to lock the vehicle's door, prompt the user to charge the vehicle (if the vehicle is an electric vehicle), lock the vehicle upon the user exiting the vehicle, and/or close the vehicle's windows upon the user exiting the vehicle.

In an illustrative non-limiting example, at step 606, the GDO 602 may initially execute a “calibrate vehicle sense” algorithm stored in a memory to determine a first signal strength threshold corresponding to the vehicle being inside the garage (e.g., inside the garage with the garage door 106 closed, inside the garage with the garage door 106 opened, and/or an average signal strength value corresponding to both) and a second signal strength threshold corresponding to the vehicle being outside the garage based on transmitter signal strength of a signal transmitted by the vehicle transmitter 604. In some embodiments, the first and second signal strength thresholds may be sent to a user device (e.g., the user device first endpoint 406 and/or the user device second endpoint 408) for display and/or storage and/or sent to a cloud server. In some embodiments, the first and second signal strength thresholds may include a fixed value and/or a range of values. In some embodiments, the garage door operator system 600 includes a camera and first and second signal strength thresholds may be used to compare with a vehicle detection algorithm that utilizes images captured by the camera to determine the location of the vehicle. An example vehicle detection algorithm is provided in U.S. Provisional Patent App. No. 63/076,728, titled Object Monitoring System, filed Sep. 10, 2020, and U.S. patent application Ser. No. 17/375,340 filed Jul. 14, 2021, which are hereby incorporated by reference herein.

In some embodiments, after an actuation of the GDO 602, the GDO 602 may communicate with the vehicle transmitter 604 and obtain a transmitter signal strength reading. For example, the GDO 602 may evaluate the transmitter signal strength received by a receiver (e.g., the receiver 206) of the GDO 602. By one approach, at step 610, if the vehicle is parked inside of the garage, the transmitter signal strength may be equal to or greater than the first signal strength threshold and/or within a threshold range of the first signal strength threshold when compared by the GDO 602. By another approach, at step 608, if the vehicle is parked outside of the garage, the transmitter signal strength may be less than the second signal strength threshold (e.g. due to signal strength attenuation resulting from the vehicle being a larger distance away from the GDO and/or because of signal propagation through a closed garage door) and/or within a threshold range of the second signal strength threshold when compared by the GDO 602. Alternatively or in addition to, the GDO 602 may determine whether the vehicle is inside or outside the garage based a comparison of the current reading of the transmitter signal strength with previously read transmitter signal strength when the garage door 106 is closed. For example, if the transmitter signal strength is very high with the garage door closed, then the GDO 602 may determine that the vehicle is in the garage. In another example, if the garage door is closed, and the received transmitter signal strength is relatively low, then the GDO 602 may determine that the vehicle is parked outside of the garage.

Geofence to Determine Promixity of a Vehicle to a Garage

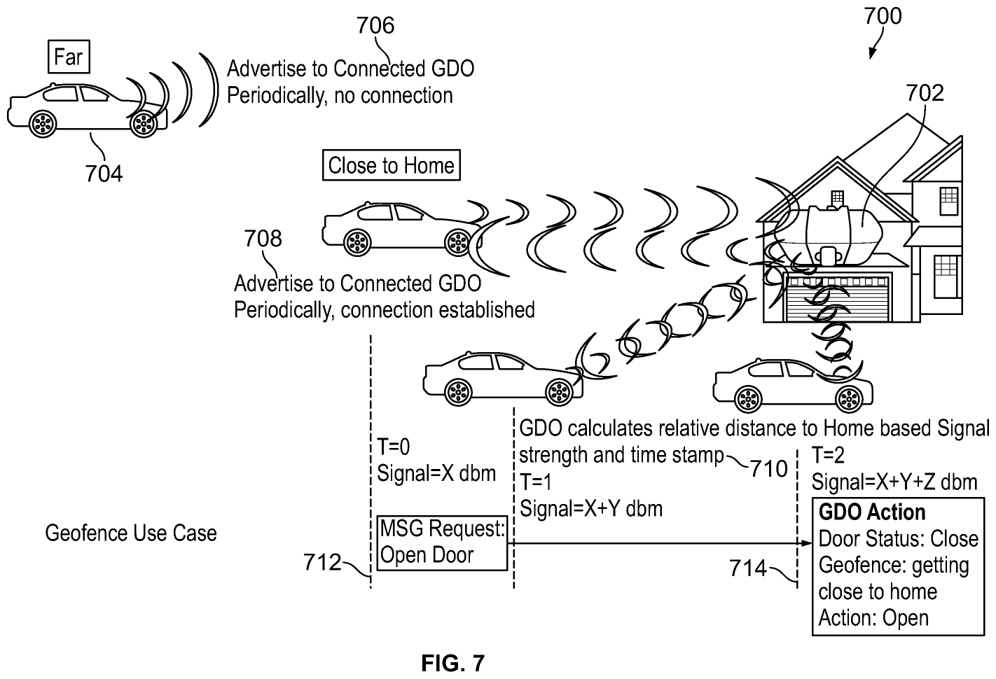

FIG. 7 is an illustration of an example operation of a garage door operator system 700. The system 700 includes a garage door operator 702 and a vehicle transmitter 704. In some embodiment, the garage door operator 702 may correspond to the garage door operator 102, the garage door operator 212 of FIG. 2, the garage door operator endpoint 302 of FIG. 3, the garage door operator endpoint 402 of FIG. 4, the GDO described in FIG. 5, and/or the garage door operator 602 of FIG. 6. In some embodiments, the vehicle transmitter 704 may correspond to the transmitter 104 of FIG. 1 and/or 2, the vehicle endpoint 304 of FIG. 3, the vehicle endpoint 404 of FIG. 4, the vehicle transmitter of FIG. 5, and/or the vehicle transmitter 604 of FIG. 6.

In some embodiments, a bi-directional communication session (for example using the Bluetooth® technology and a protocol of the '743 patent) is established between the garage door operator 702 and the vehicle transmitter 704. The garage door operator (GDO) 702 (or the corresponding control circuit of the garage door operator 702) may determine whether a vehicle associated with the vehicle transmitter 704 is getting closer to the garage and/or home based on the transmitter signal strength received at various instances of time (T) in order to change a state of one or more devices (e.g., opening of the garage door 106 when the vehicle is proximate the garage door 106, disarming a security system, unlocking a lock, turning on a light, etc.). Thus, the present disclosure facilitates the ability of the garage door operator system described herein to initiate an action at home based on the bi-directional communication established between the garage door operator 702 and the vehicle transmitter 704 and without relying on location data e.g. from a Global Positioning System (GPS) apparatus associated with a navigation unit of the vehicle. For example, at step 706, the vehicle transmitter 704 may periodically transmit a signal (e.g. advertisement message/signal) and/or determine whether a GDO signal is subsequently received. In some embodiments, at step 708, when the vehicle transmitter 704 is within a sensing threshold of the GDO 702, the GDO 702 may transmit the GDO signal in response to receiving the transmitter signal transmitted by the vehicle transmitter 704. In some embodiments, the receipt of the GDO signal by the vehicle transmitter 704 establishes an authenticated communication channel between the vehicle transmitter 704 and the GDO 702. At step 712, the vehicle transmitter 704 may send a message request for the GDO 702 to open the garage door 106. At step 710, the GDO 702 may periodically calculate relative distance of the vehicle to home based on the increasing signal strength of the signal transmitted by the vehicle transmitter 704 and received by the GDO 702 as illustrated by the increasing transmitter signal strength in decibel (dBm) unit for each successive time interval (e.g., T=0, T=1, and T=2). At step 714, the GDO 702 may determine that the vehicle is close to home when signal strength increases as time progresses, and may therefore initiate the opening of the garage door 106.

Automatic Connection Retries

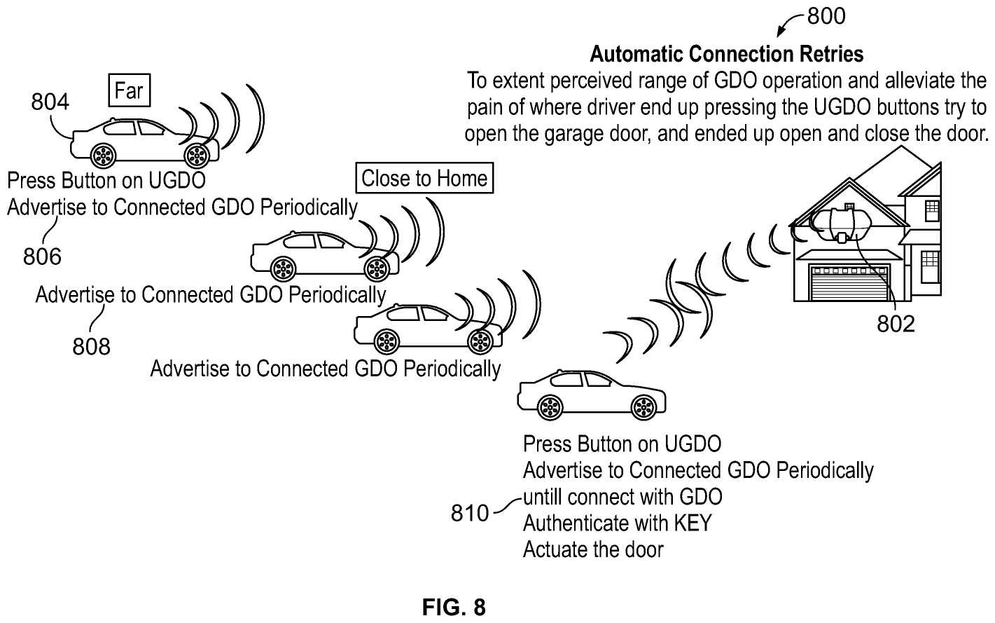

FIG. 8 is an illustration of an example operation of a garage door operator system 800 in accordance with some embodiments. The system 800 includes a garage door operator (GDO) 802 and a vehicle transmitter 804. In some embodiment, the garage door operator 802 may correspond to the garage door operator 102, the garage door operator 212 of FIG. 2, the garage door operator endpoint 302 of FIG. 3, the garage door operator endpoint 402 of FIG. 4, the GDO of FIG. 5, the garage door operator 602 of FIG. 6, and/or the garage door operator 702 of FIG. 7. In some embodiments, the vehicle transmitter 804 may correspond to the transmitter 104 of FIG. 1 and/or 2, the vehicle endpoint 304 of FIG. 3, the vehicle endpoint 404 of FIG. 4, the vehicle transmitter described in FIG. 5, the vehicle transmitter 604 of FIG. 6, and/or the vehicle transmitter 704 of FIG. 7.

In some embodiments, at step 806, after a single receipt of a user input to the vehicle transmitter 804 such as a single button press at a first time, the vehicle transmitter 804 initiates a periodic and/or constant transmission and/or emission of a transmitter signal to establish a connection and/or a communication session with the GDO 802. In some embodiments, the vehicle transmitter 804 may wait for a period of time prior to continuing the transmission of the transmitter signal in order to receive a GDO signal. At step 808, when the vehicle transmitter 804 determines that a GDO signal is not received, the periodic and/or constant transmission and/or emission of the transmitter signal continues. In some embodiments, at step 810, the user may provide a user input to the vehicle transmitter 804 at a second time and the vehicle transmitter 804 may continue the periodic and/or constant transmission of the transmitter signal until a GDO signal is received by the vehicle transmitter 804 from the GDO 802. In some embodiments, subsequent to the receipt of the GDO signal by the vehicle UGDO 804, a bi-directional communication (for example using Bluetooth® technology and a security protocol of the '743 patent) is established between the garage door operator 802 and the vehicle transmitter 804. For example, the establishment of an authenticated bi-directional communication along with the user pressing the button and/or providing the user input to the vehicle transmitter 804 for the second time, the GDO 802 may initiate the actuation of the garage door 106. In some embodiments, the GDO 802 may use the combination of the garage door information and the signal strength and time stamp to determine whether to open, close, or provide no action to the garage door 106.

As such, the present disclosure facilitates the elimination of the multiple button presses that may cause unwanted action from the garage door 106 (e.g., opening and subsequent closing of the garage door 106 due to the user pressing the button multiple times). In some embodiments, after the bi-directional communication is established and/or once the GDO signal is received by the vehicle transmitter 804, the vehicle transmitter 804 may increase the rate of transmission of the transmitter signal relative to the rate of transmission of the transmitter signal prior to the vehicle transmitter 804 receiving the GDO signal in order for the GDO 802 to frequently update the distance of the vehicle from the garage/home.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. It is intended that the phrase “at least one of” as used herein be interpreted in the disjunctive sense. For example, the phrase “at least one of A and B” is intended to encompass A, B, or both A and B.

While there have been illustrated and described particular embodiments of the present invention, it will be appreciated that numerous changes and modifications will occur to those skilled in the art, and it is intended for the present invention to cover all those changes and modifications which fall within the scope of the appended claims.

We claim:

1. A movable barrier operator system as shown and described herein.

2. A movable barrier operator system comprising:
an electric motor;
communication circuitry; and
a control circuit operatively connected to the electric motor and the communication circuitry, the control circuit configured to control operation of the electric motor based on a control signal received by the communication circuitry.
